(19) United States
(12) Patent Application Publication
(10) Pub. No.: US 2007/0102023 A1
(43) Pub. Date: May 10, 2007

(54) Apparatus for treating substrates with phosphoric acid solution and method for regenerating the phosphoric acid solution employed therein

(76) Inventors: Hun-jung Yi, Suwon-si (KR); Byung-kwang Byun, Hwaseong-si (KR); Gyung-soo Kim, Suwon-si (KR); Jai-young Woo, Cheonan-si (KR); Dong-won Hwang, Suwon-si (KR); Seung-ki Chae, Seoul (KR); Yang-koo Lee, Gwacheon-si (KR); Sang-hee Kim, Suwon-si (KR); Young-hwan Park, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 11/594,755

(22) Filed: Nov. 9, 2006

(30) Foreign Application Priority Data
Nov. 10, 2005 (KR) 2005-107754

(51) Int. Cl. B08B 7/04; B08B 3/00

(52) U.S. Cl. 134/10; 134/105; 134/111; 134/109; 134/108

(57) ABSTRACT

An apparatus and method for removing silicate from a phosphoric acid solution, including a treating unit, a regeneration line coupled to the treating unit, an additive solution supply member in communication with the regeneration line to decrease the temperature of the phosphoric acid solution and the concentration of the phosphoric acid therein, a filter in communication with the regeneration line to remove precipitated silicate particles, and a heating member having a heater and a vaporizing chamber to remove the additive.

### BACKGROUND OF THE INVENTION

1. Field of the Invention

The present invention relates to substrate treating equipment employed in semiconductor manufacturing. In particular, the present invention relates to an apparatus employed for removing residues from semiconductor wafers with a phosphoric acid solution and a method for regenerating the phosphoric acid employed therein.

2. Description of the Related Art

In general, manufacturing of semiconductor devices may require multiple-step wafer processing, such as deposition, photographic processing, etching, polishing, diffusion and so forth. Between the various processing steps, cleaning procedures may be incorporated in order to remove any residual chemicals, small particles, contaminants or unnecessary layers from the semiconductor devices being processed. Proper cleaning procedures may be important due to the thin and fragile nature of wafers employed in the semiconductor industry.

The cleaning procedure of a semiconductor wafer may include a treatment with a chemical solution to remove and/or etch unwanted portions and/or residues from the wafer, a rinsing process with deionized water to remove any remains of the chemical solution, and a drying process to remove any water and/or moisture from the rinsed semiconductor wafer. In particular, a phosphoric acid solution may be used for removing unwanted residues, i.e., silicate by-products, such as silicon nitride or a silicon oxide, from the wafer.

In general, when a phosphoric acid solution is used in a cleaning procedure of a semiconductor wafer, the phosphoric acid solution may be supplied to a treating bath in an amount sufficient to immerse a plurality of wafers therein. The phosphoric acid solution employed in the treating bath may be repeatedly circulated through a circulation line for wafer treatment, thereby obtaining increased concentration of silicate by-products dissolved therein.

However, an increased concentration of silicate by-products in the phosphoric acid solution may lower the phosphoric acid concentration and, thereby, reduce the efficiency of residue removal from the wafer, i.e., etch rate, and produce wafers with traces of residue. Even though the concentration of silicate by-products in the phosphoric acid solution may be reduced by decreasing the recycling frequency of the phosphoric acid solution, such a step may not be advantageous due to consequential increase in the required amount of phosphoric acid solution and, thereby, overall costs.

Therefore, there exists a need for an efficient semiconductor substrate treating apparatus having improved recycling system of a phosphoric acid solution capable of maintaining low silicate by-product concentration therein.

### SUMMARY OF THE INVENTION

The present invention is therefore directed to a semiconductor substrate treating apparatus and a method of providing a treating solution for the same, which substantially overcome one or more of the problems due to the limitations and disadvantages of the related art.

It is therefore a feature of an embodiment of the present invention to provide a semiconductor substrate treating apparatus having an improved recycling system of a phosphoric acid solution capable of maintaining low silicate by-product concentration therein.

It is therefore another feature of an embodiment of the present invention to provide a semiconductor substrate treating apparatus exhibiting enhanced etch uniformity while employing phosphoric acid solution to remove residuals therefrom.

It is yet another feature of an embodiment of the present invention to provide a method for regenerating a phosphoric acid solution employed in a semiconductor substrate treating apparatus.

At least one of the above and other features and advantages of the present invention may be realized by providing a substrate treating apparatus for removing a residue with a phosphoric acid solution, including a treating unit, a regeneration line coupled to the treating unit, an additive solution supply member in communication with the regeneration line, a filter in communication with the regeneration line, and a heating member having a heater and a vaporizing chamber.

The substrate treating apparatus of the present invention may further include a cooling member having a heat exchange pipe. Additionally, the apparatus may include a mixing tank. The apparatus of the present invention may also include a withdrawing pipe coupled between the heating member and the additive solution supply member. Finally, the apparatus may also include a circulation line coupled to the treating unit, wherein the circulation line may be connected in parallel to the regeneration line. The treating unit of the apparatus may include a treating bath.

In another aspect of the present invention, there is provided a method of regenerating a phosphoric acid solution used in a substrate treating apparatus, including adding an additive to the phosphoric acid solution to form an additive mixture, filtering the additive mixture to form a filtered mixture, and heating the filtered mixture to form a regenerated phosphoric acid solution.

Adding an additive to the phosphoric acid solution may include adding an alcohol. Preferably, adding the alcohol may include adding a methanol. Adding the additive to the phosphoric acid solution may also include mixing the additive with the phosphoric acid solution in a mixing unit.

Heating the filtered mixture may include evaporating the additive.

Additionally, the inventive method may include recycling the evaporated additive. Filtering the additive mixture may include removing precipitated silicate particles. The inventive method may further include cooling the phosphoric acid solution prior to adding the additive.

In yet another aspect of the present invention, there is provided a regeneration system for removing silicate particles from a phosphoric acid solution, including a regeneration line, an additive solution supply member in fluid communication with the regeneration line, a filter positioned downstream from the additive solution supply member, and a heating member including a heater and a vaporizing chamber.

The inventive regeneration system may further include a cooling member having a heat exchange pipe. Additionally, the regeneration system may include a withdrawing pipe coupled between the heating member and the additive solution supply member.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a schematic view of a semiconductor substrate treating apparatus according to an embodiment of the present invention; and

FIG. 2 illustrates a flowchart showing a method for regenerating a phosphoric acid solution employed in a semiconductor substrate treating apparatus according to an embodiment of the present invention.

### DETAILED DESCRIPTION OF THE INVENTION

Korean Patent Application No. 2005-107754, filed on Nov. 10, 2005, in the Korean Intellectual Property Office, and entitled: “Method and Apparatus for Regenerating Phosphoric Acid Solution and Apparatus for Treating Substrate Using Phosphoric Acid Solution,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of elements and regions may be exaggerated for clarity of illustration. It will also be understood that when an element is referred to as being “on” another element or substrate, it can be directly on the other element or substrate, or intervening elements may also be present. Further, it will be understood that when an element is referred to as being “under” another element, it can be directly under, or one or more intervening elements may also be present. In addition, it will also be understood that when an element is referred to as being “between” two elements, it can be the only element between the two elements, or one or more intervening elements may also be present. Like reference numerals refer to like elements throughout.

As discussed previously, the phosphoric acid solution employed in semiconductor cleaning apparatuses may contain relatively high concentration of silicate by-products that may unfavorably affect wafer cleaning. Therefore, in accordance with an embodiment of the present invention, such silicate by-products may be removed by precipitation thereof. In particular, the solubility of such silicate by-products, e.g., silicon nitride (Si₃N₄), silicon oxide (SiO₂), and so forth, may be lowered by controlling the temperature of the phosphoric acid solution and the concentration of the phosphoric acid therein, in order to facilitate precipitation of silicate from the phosphoric acid solution.

Without intending to be bound by theory, it is believed that the solubility of silicate in the phosphoric acid solution is proportional to the temperature of the phosphoric acid solution and the concentration of the phosphoric acid therein. Accordingly, the apparatus and method according to the present invention are believed to be advantageous in decreasing the temperature of the phosphoric acid solution and/or the concentration of the phosphoric acid therein. In particular, the apparatus of the present invention may include a regeneration system capable of decreasing the solubility of the silicate by-products in the phosphoric acid solution to precipitate particles thereof out of phosphoric acid solution and filter out the precipitated silicate particles before reusing the phosphoric acid solution for cleaning and/or etching purposes.

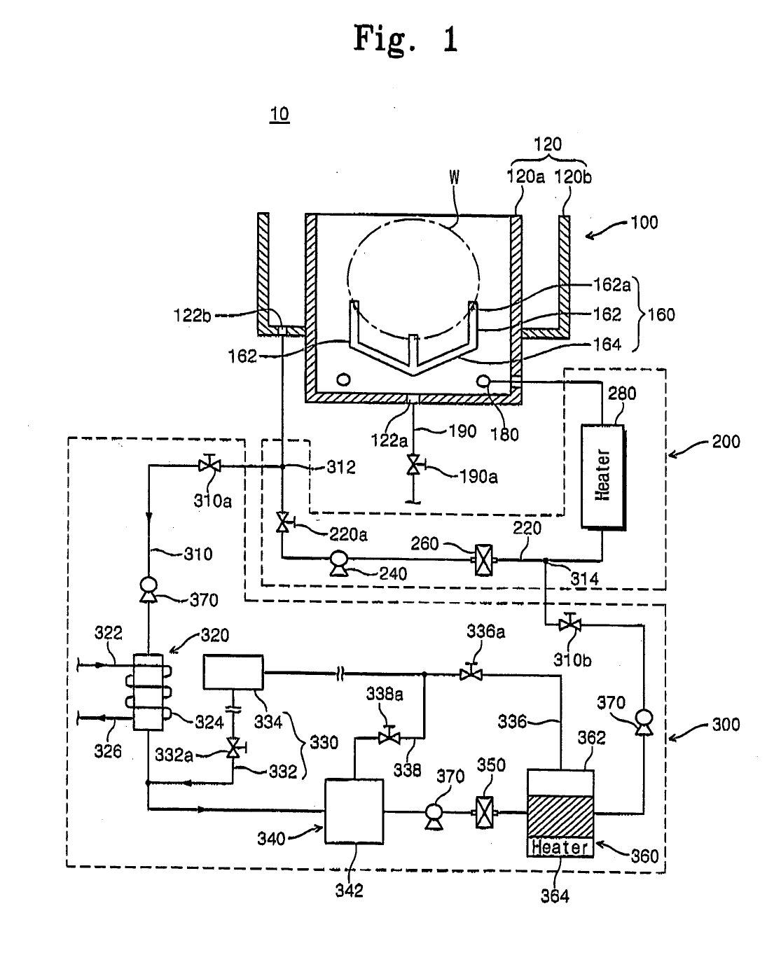

An exemplary embodiment of the present invention is more fully described below with reference to FIG. 1, which illustrates a semiconductor substrate treating apparatus according to an embodiment of the present invention. Accordingly, as can be seen in FIG. 1, a substrate treating apparatus 10 according to an embodiment of the present invention may include a treating unit 100 to remove any unnecessary residues or layers from a semiconductor wafer with a phosphoric acid solution, a circulation system 200 to circulate the phosphoric acid solution discharged from the treating unit 100, and a regeneration system 300 to remove any silicate by-products generated in the treating unit 100 and dissolved in the phosphoric acid solution.

The treating unit 100 may include a treating bath 120 having an inner bath 120a and an outer bath 120b, a supporting frame 160, and at least one supply nozzle 180.

The inner bath 120a of the treating bath 120 may be any suitable vessel for containing caustic fluids, e.g., phosphoric acid solution, and providing a substrate treatment therein. The inner bath 120a may be formed to have a bottom and four walls attached thereto, such that the inner bath 120a may have an open upper side. As illustrated in FIG. 1, the inner bath 120a may include an inner outlet 122a formed through its bottom to facilitate drainage of fluids therefrom. A drainage pipe 190 having a valve 190a may be connected to the inner outlet 122a. The outer bath 120b of the treating bath 120 may be any suitable vessel for containing caustic fluids, e.g., phosphoric acid solution, and it may be formed to surround the inner bath 120a in order to collect any fluid overflow from the inner bath 120a. The outer bath 120b may include an outer outlet 122b formed through its bottom to facilitate drainage of fluids therefrom. The outer outlet 122b may be employed, for example, for transferring a phosphoric acid solution from the treating bath 120 into the circulation system 200.

In this respect, it should be noted that the treating bath 120 of the treating unit 100 according the embodiment described above may be formed as a batch-type vessel, wherein at least one wafer W, and preferably a plurality of wafers W, may be immersed in a treating fluid, e.g., phosphoric acid solution, to remove unnecessary layers and/or residues therefrom. However, other types of treating baths 120 are not excluded from the scope of this invention. For example, the treating unit 100 may include a treating bath 120, where a single rotating wafer W may be treated with a flow of a treating fluid, e.g., phosphoric acid solution. Further, the treating fluid employed for cleaning a semiconductor wafer W according to an embodiment of the present invention may be any solution capable of removing, e.g., etching, layers and/or residue of silicon nitride or silicon oxide from a semiconductor wafer. A preferred treating fluid in the present invention may be a phosphoric acid solution. The phosphoric acid solution may contain predetermined ratios of phosphoric acid and deionized water.

As further illustrated in FIG. 1, the supporting frame 160 of the treating unit 100 may be positioned inside the inner bath 120a to support at least one semiconductor wafer W, and preferably, a plurality of wafers W. The supporting frame 160 may include a plurality of supporting rods 162 and a coupling plate 164 connecting the supporting rods 162, as illustrated in FIG. 1. The supporting rods 162 of the supporting frame 160 may be formed parallel to each other and perpendicular to the bottom of the inner bath 120a. Each supporting rod 162 may include a plurality of slots 162a along its longitudinal direction, such that a part of an edge of a wafer W may be inserted therein. In particular, each supporting rod 162 may have from about 25 to about 50 slots 162a, such that the supporting frame 160 may support from about 25 to about 50 wafers W simultaneously.

The supply nozzle 180 of the treating unit 100 may be connected to a lower part of the inner bath 120a, i.e., below the supporting frame 160, to supply fluids into the inner bath 120a for wafer W treatment. The supply nozzle 180 may have a longitudinal shape, i.e., a rod-shape, and it may be disposed inside the inner bath 120a in a direction parallel to the supporting rods 162. The treating unit 100 may include a plurality of supply nozzles 180.

The circulation system 200 according to an embodiment of the present invention may circulate the phosphoric acid solution discharged from the treating unit 100. In particular, the phosphoric acid solution discharged from the treating bath 120 may be filtered through the circulation system 200 to remove contaminants, heated to a predetermined process temperature, and subsequently, supplied back into the treating bath 120 through the supply nozzle 180 for further wafer treatment. As illustrated in FIG. 1, the circulation system 200 of the substrate treating apparatus 10 may include a circulation line 220 having a valve 220a, a pump 240, a filter 260, and a heater 280.

The circulation line 220 may be coupled between the outer outlet 122b of the outer bath 120b and the supply nozzle 180. Alternatively, the circulation line 220 may be connected to the inner outlet 122a of the inner bath 120a at its first end. The circulation line 220 may also be connected to both inner/outer outlets 122a and 122b simultaneously, while the valves 190a and 220a may control the flow through the drainage pipe 190 and circulation line 220, respectively.

The pump 240 may control a flow of the phosphoric acid solution through the circulation line 220, the filter 260 may remove contaminants contained in the phosphoric acid solution flowing through the circulation line 220, and the heater 280 may heat the phosphoric acid solution up to a predetermined process temperature. The pump 240, the filter 260, and the heater 280 may be installed on the circulation line 220 in any method known to one of ordinary skill in the art. For example, the pump 240, the filter 260 and the heater 280 may be positioned sequentially along a direction of flow of the phosphoric acid solution in the circulation line 220.

The regeneration system 300 of the substrate treating apparatus 10 according to an embodiment of the present invention may remove any by-products generated in the treating unit 100, e.g., silicate by-products, such as silicate nitride and silicate oxide, formed during the treatment of the semiconductor wafers and dissolved in the phosphoric acid solution. Such removal of silicate by-products may regenerate the phosphoric acid solution and, thereby, increase its reuse frequency. In this respect, it should be noted that “regenerated” or like terminology refers to a phosphoric acid solution having a substantial amount of by-products, e.g., silicate compounds, removed therefrom, thereby containing a concentration of phosphoric acid that is sufficient to efficiently and uniformly remove residues from semiconductor wafers.

As further illustrated in FIG. 1, the regeneration system 300 may include a regeneration line 310 having valves 310a and 310b and at least one pump 370 to control the flow of the phosphoric acid solution, a cooling member 320, an additive solution supply member 330, a mixing member 340, a filter 350, and a heating member 360.

The regeneration line 310 may be connected to a first position 312 on the circulation line 220 at one end and to a second position 314 on the circulation line 220 at another end. In other words, the regeneration line 310 and the circulation line 220 may be connected in parallel, having the first and second positions 312 and 314, respectively, as their connection points. The first and second positions 312 and 314, respectively, may be located anywhere on the circulation line 220 as may be determined by one of ordinary skill in the art. For example, the first position 312 may be located on the circulation line 220 between the outer outlet 122b of the outer bath 120b and the pump 240, as illustrated in FIG. 1, and the second position 314 may be located on the circulation line 220 between the filter 260 and the heater 280, as further illustrated in FIG. 1.

In this respect, it should be noted that if the first position 312 is located on the circulation line 220 between the outer outlet 122b of the outer bath 120b and the pump 240, the valve 220a may be positioned between the first position 312 and the pump 240, as illustrated in FIG. 1.

The cooling member 320 of the regeneration system 300 may be coupled to the regeneration line 310 in order to lower the temperature of the phosphoric acid solution flowing therein. The cooling member 320 may include a cooling water supply pipe 322, a heat exchange pipe 324, and a cooling water withdrawing pipe 326. The heat exchange pipe 324 may be in communication with the cooling water supply pipe 322 and the cooling water withdrawing pipe 326, and it may be positioned to partially overlap with the regeneration line 310 in order to provide sufficient contact area therebetween for heat-exchange. For example, the heat exchange pipe 324 may be formed as a coil, and it may be wrapped around the regeneration line 310 to provide sufficient contact area for heat exchange. Accordingly, cooling water flowing through the cooling water supply pipe 322 may continue through the heat exchange pipe 324 surrounding the regeneration line 310, thereby reducing the temperature of the fluid flowing through the regeneration line 310. Subsequently, the cooling water may be disposed from the heat exchange pipe 324 through the cooling water withdrawing pipe 326.

The additive solution supply member 330 of the regeneration system 300 may be positioned in communication with the regeneration line 310 in order to lower the temperature of the phosphoric acid solution and the concentration of the phosphoric acid in the phosphoric acid solution flowing therein. In particular, the additive solution supply member 330 may supply an additive, preferably an alcohol, into the phosphoric acid solution flowing through the regeneration line 310.

Without intending to be bound by theory, it is believed that the temperature of the phosphoric acid solution entering the regeneration line 310 and/or exiting the cooling member 320 is sufficiently high to vaporize the additive. Accordingly, supply of an additive into the phosphoric acid solution may generate sufficient heat to produce additive vaporization heat, thereby reducing the temperature of the phosphoric acid solution. Further, mixing of an additive with the phosphoric acid solution is believed to reduce the concentration of the phosphoric acid in the phosphoric acid solution, thereby reducing the solubility of silicate in the phosphoric acid solution and causing its precipitation out of the phosphoric acid solution.

The additive solution supply member 330 may include an additive supply pipe 332 having a flow control valve 332a and an additive storage tank 334 for storing an additive. The additive supply pipe 332 may be positioned between the additive storage tank 334 and the regeneration line 310, such that an additive may be supplied from the additive storage tank 334 through the additive supply pipe 332 to the regeneration line 310. The additive supply pipe 332 may be connected to the regeneration line 310 between the cooling member 320 and the mixing member 340, as illustrated in FIG. 1, such that the additive may be added into the phosphoric acid solution flowing in the regeneration line 310 after temperature reduction thereof by the cooling member 320. Alternatively, the additive supply pipe 332 may be connected to the regeneration line 310 upstream from the cooling member 320, such that the additive may be added into the phosphoric acid solution flowing in the regeneration line 310 before temperature reduction thereof by the cooling member 320.

The mixing member 340 of the regeneration system 300 may include a mixing tank 342 having a mixer (not shown) to provide uniform mixing of the additive and the phosphoric acid solution. The mixing member 340 may be positioned in communication with the regeneration line 310 in order to mix the additive provided via the additive supply pipe 332 and the phosphoric acid solution flowing through the regeneration line 310. Accordingly, the mixing member 340 may be positioned downstream from the cooling member 320 and from a connection point between the additive supply line 332 and the regeneration line 310, as illustrated in FIG. 1. Alternatively, the additive supply pipe 332 may be directly connected to the mixing tank 342, i.e., the additive supply pipe 332 may not have a direct connection point with the regeneration line 310. In another embodiment of the present invention, the cooling member 320, the additive supply pipe 332, and the mixing member 340 may be positioned on the regeneration line 310 such that the additive and the phosphoric acid solution may be uniformly mixed prior to temperature reduction thereof by the cooling member 320.

It should be noted that the scope of the present invention is not limited to the arrangements of the cooling member 320, the additive supply pipe 332, and the mixing member 340 described above. For example, the cooling member 320 may not be installed on the regeneration line 310, such that only the additive solution supply member 330 may be used to reduce the temperature of the phosphoric acid solution flowing in the regeneration line 310.

The filter 350 of the regeneration system 300 may be in communication with the regeneration line 310, such that it may be positioned downstream from the mixing unit 340. Accordingly, the mixture of the additive and the phosphoric acid solution may be filtered through the filter 350 to remove precipitated silicate particles.

The heating member 360 of the regeneration system 300 may heat the filtered mixture exiting the filter 350 in order to vaporize the additive from the filtered mixture. In other words, the solution exiting the heating member 360 may contain mostly phosphoric acid solution.

The heating member 360 may be in communication with the regeneration line 310, such that it may be positioned downstream from the filter 350. The heating member 360 may include a vaporizing chamber 362 and a heater 364, such that the heater 364 may be formed either on an outer wall of the vaporizing chamber 362 or inside the vaporizing chamber 362.

In accordance with the present invention and with reference to FIG. 1, an exemplary method of operation of the inventive apparatus is as follows. At least one wafer W, and preferably a plurality of wafers W, may be secured into the supporting frame 160 in the treating bath 120. A phosphoric acid solution may be supplied into the treating bath 120 through the supply nozzle 180, such that the wafers W may be completely immersed in the phosphoric acid solution to remove any silicate particles from each wafer W. The phosphoric acid solution containing dissolved silicate particles may be removed from the treating bath 120 through outer outlet 122b of the outer bath 120b into the circulation line 220, such that the phosphoric acid solution containing dissolved silicate particles may circulate a predetermined number of times back into the treating bath 120 through the filter 260 and the heater 280 of the circulation system 200.

The predetermined number of circulations of the phosphoric acid solution through the circulation system 200 may be determined by one of ordinary skill in the art with respect to the apparatus operation, e.g., the concentration of silicate particles in the phosphoric acid solution. Once the predetermined number of circulations, or alternatively, a predetermined concentration of silicate particles in the phosphoric acid solution has been reached, valve 220a of the circulation line 220 may be closed, and valve 310a of the regeneration line 310 may be open, such that the phosphoric acid solution may be discharged from the outer treating bath 120b into the regeneration line 310 of the regeneration system 300.

In this respect, it should be noted that the phosphoric acid solution employed in the treating unit 100 may be reused for wafer treatment and circulated through the circulation system 200 for a predetermined number of times prior to transfer into the regeneration system 300. Alternatively, the phosphoric acid solution employed in the treating unit 100 may be directly transferred from the treating bath 120 into the regeneration system 300 without circulation through the circulation system 200.

Next, the phosphoric acid solution may flow through the regeneration line 310. The phosphoric acid solution may either flow through the cooling member 320 to reduce the temperature thereof or mix with an additive, e.g., methanol, released from the additive supply unit 330 prior to passing through the cooling member 320. Without intending to be bound by theory, it is believed that after reduction of temperature and phosphoric acid concentration due to the cooling member 320 and/or mixing with the additive, a substantial amount of silicate particles may precipitate out of the phosphoric acid solution. The precipitated silicate particles may be removed through the filter 350, while the additive may be removed through the heating unit 360.

The phosphoric acid solution exiting the heating unit 360 may continue through the regeneration line 310 into the circulation line 220. Next, the phosphoric acid solution may pass through the heater 280 to achieve an appropriate process temperature prior to entering the treating bath 120 through the supply nozzle 180.

The additive vaporized from the mixing tank 342 and the vaporizing chamber 362 may be withdrawn through first and second withdrawing pipes 336 and 338, respectively, as illustrated in FIG. 1. The first withdrawing pipe 336 may include a first withdrawing valve 336a between the vaporizing chamber 362 and a connection point between the first and second withdrawing pipes 336 and 338, respectively. The first withdrawing pipe 336 may be connected to the vaporizing chamber 362 in order to withdraw the additive from the vaporizing chamber 362. The second withdrawing pipe 338 may include a second withdrawing valve 338a between the mixing unit 340 and the connection point between the first and second withdrawing pipes 336 and 338, respectively. The second withdrawing pipe 338 may be connected to the mixing tank 342 to withdraw the additive vaporized therein into the additive storage tank 334. The first and second withdrawing valves 336a and 338a, respectively, may open and/or close inner passages of the first and second withdrawing pipes 336 and 338, respectively. In this respect, it should be noted that all valves mentioned in reference to the present invention, e.g., valves 220a, 310a, 310b, 332, 336a, 338a, may be electrical valves, e.g., solenoid valves.

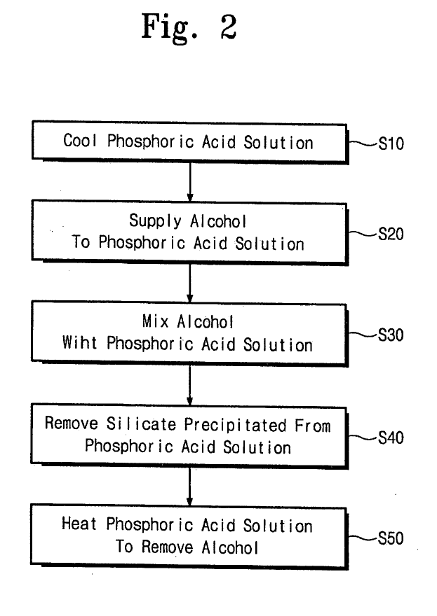

In another embodiment of the present invention illustrated in FIG. 2, a method of regenerating a phosphoric acid solution through the regeneration system 300 is described. As illustrated in FIG. 2, a phosphoric acid solution introduced into the regeneration line 310 may be cooled in step S10 in order to lower its temperature and, thereby, reduce the silicate particles solubility in the phosphoric acid solution.

Next, an additive may be added into the cool phosphoric acid solution as step S20 to form an additive mixture. The preferred additive may be an alcohol. Most preferably, the additive may be methanol. Alternatively, steps S10 and S20 may be reversed. In other words, the phosphoric acid solution may be cooled after the additive is added therein. However, it should be noted that elimination of step S10 is not excluded from the scope of this invention, since control of the phosphoric acid solution temperature may be achieved by other methods to be described below.

Subsequently, the additive mixture formed in step S20 may be passed into the mixing tank 342 as step S30 to form a uniform mixture between the additive and the phosphoric acid solution. During mixing in the mixing tank 342, energy may be transferred from the phosphoric acid solution to the additive, thereby partially vaporizing it and lowering the temperature of the phosphoric acid solution. Step S30 may further lower the solubility of silicate particles in the phosphoric acid solution, thereby precipitating particles thereof out of the phosphoric acid solution.

Next, the precipitated silicate particles may be filtered through the filter 350 in step S40. Finally, the filtered mixture containing additive, e.g., methanol, and phosphoric acid solution may be passed through the vaporizing chamber 362 of the heating member 360 in step S50 in order to vaporize the additive and remove it from the filtered mixture by way of a withdrawing pipe 336 to form a regenerated phosphoric acid solution in the heating member 360. Once the additive is removed from the filtered mixture, the phosphoric acid solution at the exit from the heating member 360 may contain an increased concentration of phosphoric acid as compared to the concentration of the phosphoric acid therein at the time of its introduction into the regeneration line 310. In other words, a regenerated phosphoric acid solution may be formed in the heating member 360.

Accordingly, the solution of phosphoric acid at the end of step S50, i.e., at the exit from the heating member 360, may be passed through the second position 314 to the circulation line 220, wherein the regenerated phosphoric acid solution may be heated in the heating unit 280 to reach a required process temperature. From the heating unit 280, the regenerated phosphoric acid solution may continue through the supply nozzle 180 into the inner bath 120a of the treating bath 120 to supply sufficient treating fluid for removing silicate residues from semiconductor wafers. The additive vaporized in the vaporizing chamber 362 and the mixing tank 342 may be withdrawn to the additive storage tank 334 through the first and second withdrawing pipes 336 and 338, respectively.

The additive employed in an embodiment of the present invention may be any liquid having a boiling point that is lower than the boiling point of the phosphoric acid solution. For example, any alcohol, i.e., a primary alcohol, a secondary alcohol, a tertiary alcohol, and so forth, or water may be used. Preferably, a primary alcohol, such as methanol, may be used.

Without intending to be bound by theory, it is believed that when a secondary or tertiary alcohol, e.g., isopropyl alcohol, is mixed with a phosphoric acid solution, a dehydrogenation reaction may take place to generate organic by-products, e.g., ether. Such by-products may be left in the phosphoric acid solution, thereby staining wafer surface during cleaning thereof with the recycled phosphoric acid solution. However, when a primary alcohol, e.g., methanol, is used as an additive, it is believed that no such by-product may be left in the phosphoric acid solution. In particular, even if such by-product, i.e., dimethyl ether, may be formed upon mixing of methanol with phosphoric acid solution, it may evaporate out of the mixture due to its low boiling point of about −24.8° C.

Another additive according to an embodiment of the present invention may be water. However, the solubility of amorphous silica in water may increase up to a maximum of about 1000 ppm. Further, an alcohol may generally have a lower boiling point and vaporization energy as compared to water. Therefore, when water is used as an additive, the amount of precipitated silicate particles out of the mixed solution of the phosphoric acid solution and the water may be relatively small, while the energy consumption may be higher as compared to the energy consumption when alcohol is used as an additive. Thus, the use of alcohol as the additive may reduce the energy consumption and, thereby, decrease the overall size of the regeneration system 300 due to a relatively lower capacitance of the heater 364.

### EXAMPLES

### Examples 1-2

a phosphoric acid is regenerated in the regeneration system 300 according to an embodiment of the present invention described above with respect to FIG. 1. Two identical samples of phosphoric acid solutions, i.e., identical amounts of phosphoric acid, deionized water, and silicate particles, are prepared and passed through the regeneration line 310 of the present invention. In particular, in Example 1, the additive mixed with the phosphoric acid solution is water, while in Example 2, the additive mixed with the phosphoric acid solution is methanol. The resulting mixtures in Examples 1-2 are passed through a filter unit to remove precipitated silicate particles as a result of the added additive. The remaining concentration of silicate particles in each mixture containing phosphoric acid solution and additive is measured and reported in terms of ppm. Further, the percentage of the silicate particles removed as compared to the initial concentration of silicate particles in each sample is reported in percentages. The results summarizing Examples 1-2 are reported in Table 1.

In order to illustrated physical properties of potential additives with respect to the heating member of the present invention and the additive evaporation therefrom, boiling points and vaporization energies of the additives used in Examples 1-2, in addition to isopropyl alcohol, are summarized in Table 2.

TABLE 1

| | | Remaining Concentration | |
|---|---|---|---|
| Example No. | Additive | of Silicate Particles (ppm) | Removal rate (%) |
| 1 | Water | 16.5 | 45 |
| 2 | Methanol | 13.5 | 55 |

As illustrated in Table 1, use of methanol as an additive in the present invention may generate a higher removal rate of silicate particles from a phosphoric acid solution, thereby providing lower silicate concentration in the phosphoric acid solution employed for cleaning semiconductor wafers.

TABLE 2

| | | Vaporization energy |
|---|---|---|
| Additive | Boiling point (° C.) | (KJ/mol) |
| Water | 100 | 40.65 |
| Methanol | 64.7 | 35.21 |
| Isopropyl alcohol | 82.5 | 39.85 |

As illustrated in Table 2, use of methanol as an additive in the present invention may require the lowest energy consumption due to its lower boiling point as compared to the water and isopropyl alcohol.

The substrate treating apparatus 10 according to an embodiment of the present invention may be advantageous because it may extend the use of the phosphoric acid solution employed for cleaning and/or etching semiconductor wafers and, thereby, provide a uniform etch rate regardless of the frequency of reuse. The extended use of the phosphoric acid solution may be efficiently achieved due to use of a alcohol, such as methanol, that may facilitate silicate precipitation, reduce energy consumption and size of the regeneration system, and minimize organic residue on treated wafer.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A substrate treating apparatus for removing a residue with a phosphoric acid solution, comprising:
a treating unit;
a regeneration line coupled to the treating unit;
an additive solution supply member in communication with the regeneration line;
a filter in communication with the regeneration line; and
a heating member having a heater and a vaporizing chamber and the heating member being positioned downstream from the filter.

2. The substrate treating apparatus as claimed in claim 1, further comprising a cooling member having a heat exchange pipe for cooling the phosphoric acid solution in the regeneration line.

3. The substrate treating apparatus as claimed in claim 1, further comprising a mixing tank for mixing an additive solution and the phosphoric acid solution, and the mixing tank being connected with the regeneration line.

4. The substrate treating apparatus as claimed in claim 1, further comprising a withdrawing pipe coupled between the heating member and the additive solution supply member.

5. The substrate treating apparatus as claimed in claim 1, further comprising a circulation line coupled to the treating unit, wherein the circulation line is connected in parallel to the regeneration line.

6. The substrate treating apparatus as claimed in claim 1, wherein the treating unit includes a treating bath.

7. A method of regenerating a phosphoric acid solution used in a substrate treating apparatus, comprising:
adding an additive to the phosphoric acid solution to form an additive mixture;
filtering the additive mixture to form a filtered mixture; and
heating the filtered mixture to form a regenerated phosphoric acid solution.

8. The method as claimed in claim 7, further comprising cooling the phosphoric acid solution prior to adding the additive.

9. The method as claimed in claim 7, wherein adding an additive to the phosphoric acid solution comprises adding an alcohol.

10. The method as claimed in claim 9, wherein adding the alcohol includes adding a methanol.

11. The method as claimed in claim 7, wherein adding an additive to the phosphoric acid solution includes mixing the additive with the phosphoric acid solution in a mixing unit.

12. The method as claimed in claim 7, wherein heating the filtered mixture includes evaporating the additive.

13. The method as claimed in claim 12, further comprising recycling the evaporated additive.

14. The method as claimed in claim 7, wherein filtering includes removing precipitated silicate particles.

15. A regeneration system for removing silicate particles from a phosphoric acid solution, comprising:
a regeneration line;
an additive solution supply member in fluid communication with the regeneration line;
a filter positioned downstream from the additive solution supply member; and
a heating member having a heater and a vaporizing chamber and the heating member being positioned downstream from the filter.

16. The regeneration system as claimed in claim 15, further comprising a cooling member having a heat exchange pipe for cooling the phosphoric acid solution in the regeneration line.

17. The regeneration system as claimed in claim 15, further comprising a withdrawing pipe coupled between the heating member and the additive solution supply member.

18. The regeneration system as claimed in claim 15, further comprising a mixing tank for mixing an additive solution and the phosphoric acid solution, and the mixing tank being connected with the regeneration line.
